(19) United States
(12) Patent Application Publication
(10) Pub. No.: US 2017/0254212 A1
(43) Pub. Date: Sep. 7, 2017

(54) A GUIDE VANE MADE OF COMPOSITE MATERIAL FOR A GAS TURBINE ENGINE, AND IT'S METHOD OF FABRICATION

(71) Applicants: SAFRAN AIRCRAFT ENGINES, Paris (FR); SAFRAN, Paris (FR)

(72) Inventors: Sébastien PAUTARD, Palaiseau (FR); Maxime BRIEND, Moissy-Cramayel Cedex (FR); Emilie TROUSSET, Malakoff (FR); Patrick DUNLEAVY, Palaiseau (FR)

(73) Assignees: SAFRAN AIRCRAFT ENGINES, Paris (FR); SAFRAN, Paris (FR)

(21) Appl. No.: 15/506,343

(22) PCT Filed: Aug. 20, 2015
(86) PCT No.: PCT/FR2015/052237

§ 371 Date: Feb. 24, 2017

(30) Foreign Application Priority Data
Aug. 27, 2014 (FR) 14 58020

(51) Int. Cl. F01D 9/02; B29C 45/40; B29C 45/00

(52) U.S. Cl. CPC F01D 9/02; B29C 45/0005; B29C 45/40; F05D 2220/32; F05D 2230/20; F05D 2300/603

(57) ABSTRACT

A guide vane for a gas turbine engine, the guide vane including an airfoil made of composite material having fiber reinforcement densified by a matrix, the fiber reinforcement being obtained from pre-impregnated long fibers agglomerated in the form of a mat, the airfoil being provided at least on a leading edge with a reinforcing strip, the reinforcing strip being made from a single strip of unidirectional fabric or of textile, or by stacking a plurality of pre-impregnated plies of unidirectional fabric or of textile made of carbon fibers or of glass fibers, and at least one platform positioned at a radial end of the airfoil, the platform being made of composite material having fiber reinforcement densified by a matrix, the fiber reinforcement being obtained from pre-impregnated long fibers.

### BACKGROUND OF THE INVENTION

The present invention relates to the general field of guide vanes for gas turbine aeroengines.

Example applications of the invention comprise in particular outlet guide vanes (OGV), inlet guide vanes (IGV), and variable stator vanes (VSV) for an aviation turbine engine.

Typically, each guide vane of a gas turbine aeroengine presents two platforms (inner and outer) that are fitted onto the airfoil. Such guide vanes form rows of stator vanes that serve to guide the gas stream passing through the engine so that it takes on appropriate speed and angle.

Guide vanes are generally made of metal, but it is becoming common practice to make them out of composite material, in particular in order to reduce their weight. Unfortunately, methods of fabricating guide vanes out of metal material or out of composite material suffer from certain drawbacks.

In particular, for metal guide vanes, the tooling used for fabricating them is expensive and takes a long time to make. Specifically, such guide vanes are typically obtained by casting, which requires two different mold bodies, namely a permanent body that is expensive and lengthy to fabricate and that requires treatment against wear, and a body made of sand with an agglomerating agent, which body needs to be remade very frequently. Furthermore, that type of guide vane requires a stage of finishing by machining or by chemical treatment in order to finalize the part.

Guide vanes made of composite material are usually made by various fabrication methods, such as for example the manual laminating/draping method, the method of molding by injecting a fiber preform (known as resin transfer molding (RTM)), the method of infusion with liquid resin, the embroidery method (also known as tailored fiber placement), the thermo-compression method, etc.

Laminating/draping methods are expensive, and furthermore they are not adapted to fabricating guide vanes of small sizes or having complex form factors. Resin injection methods lead to faulty positioning of the fiber preform while it is being shaped or while it is being consolidated, and there are also risks of delamination between laminations. Furthermore, some of those fabrication methods require separate platforms to be fitted to the airfoil, leading to additional fabrication costs.

Furthermore, guide vanes made of composite material require metal foil to be fitted to their leading edges in order to protect them against erosion, abrasion, and impact from foreign bodies. Unfortunately, shaping and assembling metal foil on the leading edge of an airfoil is an additional operation that is lengthy and expensive.

### OBJECT AND SUMMARY OF THE INVENTION

There therefore exists a need to be able to have a guide vane that does not present the drawbacks associated with the above-mentioned fabrication methods.

In accordance with the invention, this object is achieved by a guide vane for a gas turbine engine, the guide vane comprising an airfoil made of composite material having fiber reinforcement densified by a matrix, the fiber reinforcement being obtained from pre-impregnated long fibers agglomerated in the form of a mat, the airfoil being provided at least on a leading edge with a reinforcing strip, and at least one platform positioned at a radial end of the airfoil, the platform being made of composite material having fiber reinforcement densified by a matrix, said fiber reinforcement being obtained from pre-impregnated long fibers.

The guide vane of the invention is remarkable in that it presents hybrid architecture comprising an airfoil made of a mat obtained by agglomerating pre-impregnated long fibers, and having a reinforcing strip assembled on its leading edge. The term “mat” is used herein to mean a set of filaments, of discontinuous fibers, or of base fibers, that may optionally be cut, and that are held together in the form of a sheet, a mat, or an off-cut.

In particular, the mat made of long fibers, e.g. discontinuous fibers, serves to give the guide vane overall stiffness, and the reinforcing strip accentuates stiffness locally so as to limit bending of the guide vane and avoid unacceptable vibratory modes while also limiting deformation. The structure of the long fiber mat also serves to confer an isotropic structure with mechanical properties that are uniform in the plane of the blade.

Thus, such an architecture presents numerous advantages compared with architectures known in the prior art, in particular in terms of stiffness, of cost, and of ease of fabrication. Furthermore, the choice of materials used and the fabrication method used enable this architecture to present a large degree of modularity concerning the topology of the guide vane as a function of mechanical stresses and of positioning within the engine.

The reinforcing strip may be positioned on the leading edge of the airfoil and may cover at least part of one of the side faces of the airfoil.

The reinforcing strip serves to provide the airfoil with a leading edge of composite material that serves to protect it from problems of abrasion, erosion, and impacts from foreign bodies. In this configuration covering at least part of one of the side faces of the airfoil, the reinforcing strip also serves to further increase the stiffness of the airfoil, and in particular in its thickness direction.

Still in this configuration, the side face of the airfoil that is not covered by the reinforcing strip is advantageously covered in part by another strip of unidirectional fabric so as to limit stiffness and shrinkage asymmetries during fabrication of the airfoil.

Alternatively, the reinforcing strip may be positioned at the leading edge of the airfoil, and may cover both side faces of the airfoil, at least in part. In this configuration, the reinforcing strip thus serves to increase the stiffness of the airfoil greatly.

Thus, using the same architecture for the guide vane, and merely by modifying the width of the reinforcing strip, it is possible to provide guide vanes of different categories, namely a guide vane that is stressed purely aerodynamically, a guide vane that is not structural, and a guide vane that is semi-structural, while also providing protection to the leading edge of its airfoil.

Preferably, the reinforcing strip is positioned on the airfoil and on at least one connection fillet between the airfoil and the platform.

The guide vane may further include a layer of viscoelastic material that is interposed between the airfoil and the reinforcing strip or that is positioned within the reinforcing strip. The presence of such a viscoelastic layer (or patch) serves to respond to vibratory, acoustic, or damping problems to which the guide vane is subjected.

The reinforcing strip is made from a single strip of unidirectional fabric or of textile, or by stacking a plurality of pre-impregnated plies of unidirectional fabric or of textile made of carbon fibers (of types that are qualified as follows: M for standard, IM for intermediate modulus, HR for high strength, HM for high modulus), or made of glass fibers. In particular, the width of the reinforcing strip and the type of carbon used are a function of the forces to which the guide vane is subjected. A pre-impregnated fabric can thus be used with a weave and/or sequence of plies that are predefined as a function of the stiffness required of the airfoil. In particular, with textile reinforcement, the preferred orientation may vary so as to facilitate implementation of the reinforcement over the airfoil. Concerning the embodiment presenting glass fibers, said fabric or textile reinforcement made up of glass fibers can increase stiffness a little and can also provide protection against abrasion and/or erosion, thereby protecting the vane.

Preferably, the mats constituting the fiber reinforcement of the airfoil and of the platform are made from carbon fiber chips. The size of these chips (i.e. their length and width) and the type of carbon used depend on the stresses to which the airfoil is subjected.

The invention also provides a turbine engine including at least one guide vane as defined above.

The invention also provides a method of fabricating a guide vane as defined above, the method comprising in succession: positioning the reinforcing strip and the pre-impregnated long fibers that are agglomerated as mats in cavities of compression tooling in order to make fiber reinforcement making up the airfoil and the platform; closing the compression tooling; compressing the mats and the reinforcing strip while regulating the temperature and the closure pressure of the compression tooling in order to transform the composite used; opening the compression tooling; and unmolding the resulting guide vane.

In an alternative, the method of fabricating a guide vane as defined above comprises in succession: positioning the reinforcing strip and the pre-impregnated long fibers that are agglomerated as mats in cavities of compression tooling in order to make fiber reinforcement constituting the airfoil; closing the compression tooling; compressing the mats and the reinforcing strip while regulating the temperature and the closure pressure of the compression tooling in order to transform the composite used; opening the compression tooling; unmolding the resulting airfoil; and overmolding a previously-prepared platform on the airfoil by a method of injecting resin under pressure.

In another alternative, the method of fabricating a guide vane as defined above comprises in succession: positioning the reinforcing strip and the pre-impregnated long fibers that are agglomerated as mats in cavities of compression tooling in order to make fiber reinforcement constituting the airfoil; closing the compression tooling; compressing the mats and the reinforcing strip while regulating the temperature and the closure pressure of the compression tooling in order to transform the composite used; opening the compression tooling; unmolding the resulting airfoil; and adhesively bonding a previously-prepared platform on the airfoil.

### BRIEF DESCRIPTION OF THE DRAWINGS

Other characteristics and advantages of the present invention appear from the following description made with reference to the accompanying drawings, which show embodiments having no limiting character. In the figures:

FIG. 1 is a perspective view of a guide vane of the invention;

FIGS. 2A and 2B are views of the FIG. 1 guide vane, respectively in cross-section and in longitudinal section; and

FIGS. 3 to 6 are cross-section vies of guide vanes in variant embodiments of the invention.

### DETAILED DESCRIPTION OF THE INVENTION

The invention applies to making guide vanes for a gas turbine aeroengine, each vane having a leading edge.

Non-limiting examples of such guide vanes include in particular outlet guide vanes (OGV), inlet guide vanes (IGV), and variable stator vanes (VSV), etc.

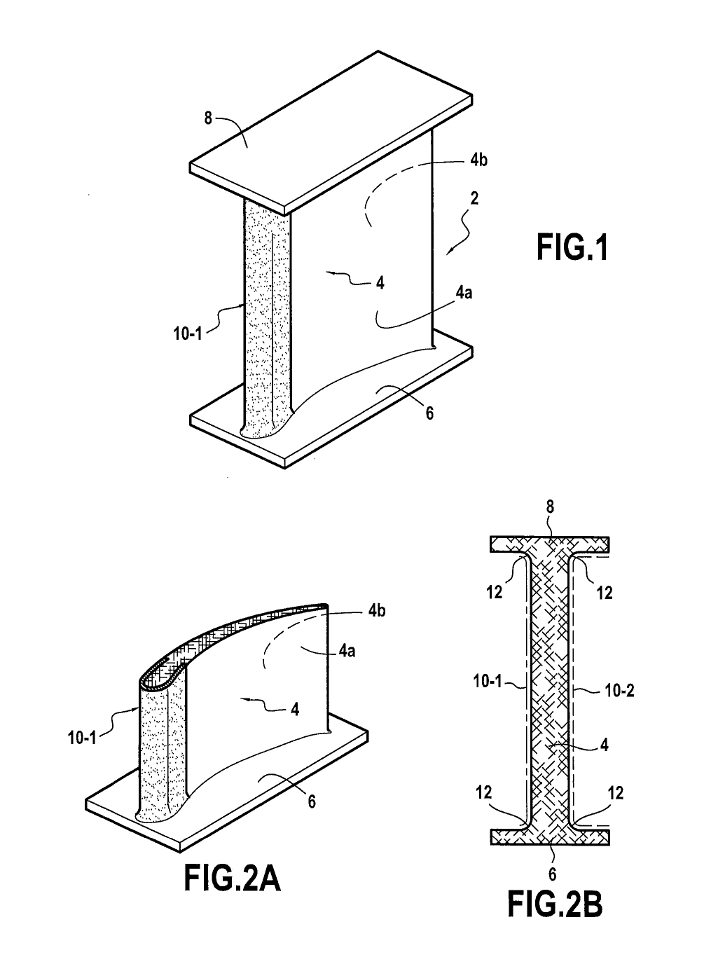

FIG. 1 is a diagrammatic perspective view showing an example of such a guide vane 2.

In known manner, the guide vane 2 comprises an airfoil 4 having a pressure side face 4a and a suction side face 4b, an inner platform 6 that is assembled on a radially inner end of the airfoil, and an outer platform 8 that is assembled on the radially outer end of the airfoil.

In accordance with the invention, the airfoil 4 is made of composite material having fiber reinforcement densified by a matrix, the fiber reinforcement being obtained from pre-impregnated long fibers, e.g. discontinuous fibers that are agglomerated in the form of a mat. The fabrication of such an airfoil is described below.

In the same manner, the inner and outer platforms 6 and 8 are made out of composite material with fiber reinforcement likewise obtained from pre-impregnated long fibers, e.g. discontinuous fibers that are agglomerated in the form of a mat.

Furthermore, still in accordance with the invention, and as shown in FIGS. 2A and 2B, the leading edge of the airfoil 4 is formed by a reinforcing strip 10-1 made of unidirectional fabric (UD) or of pre-impregnated textile, this reinforcing strip being positioned on the airfoil at its leading edge and at least on the connection fillets 12 between the airfoil and the inner and outer platforms 6 and 8. The reinforcing strip could optionally not cover the connection fillets.

In the left-hand portion of FIG. 2B, the reinforcing strip 10-1 extends only over the connection fillets 12 between the airfoil and the inner and outer platforms 6 and 8. Alternatively, and as shown in the right-hand portion of FIG. 2B, the reinforcing strip 10-2 could extend not only over the connection fillets, but also over the platforms 6 and 8.

Furthermore, in another embodiment that is not shown in the figures, the reinforcing strip may be embedded directly in the thickness of the platforms 6 and 8. This technique serves to avoid any delamination between the reinforcing strip and the mat constituting the platforms during drilling and rolling of the platforms for the purpose of fastening them to a casing.

Furthermore, and as shown in FIG. 2A, the reinforcing strip 10-1 may present positioning that is said to be “simple”, in which case it is positioned only on the leading edge of the airfoil 4.

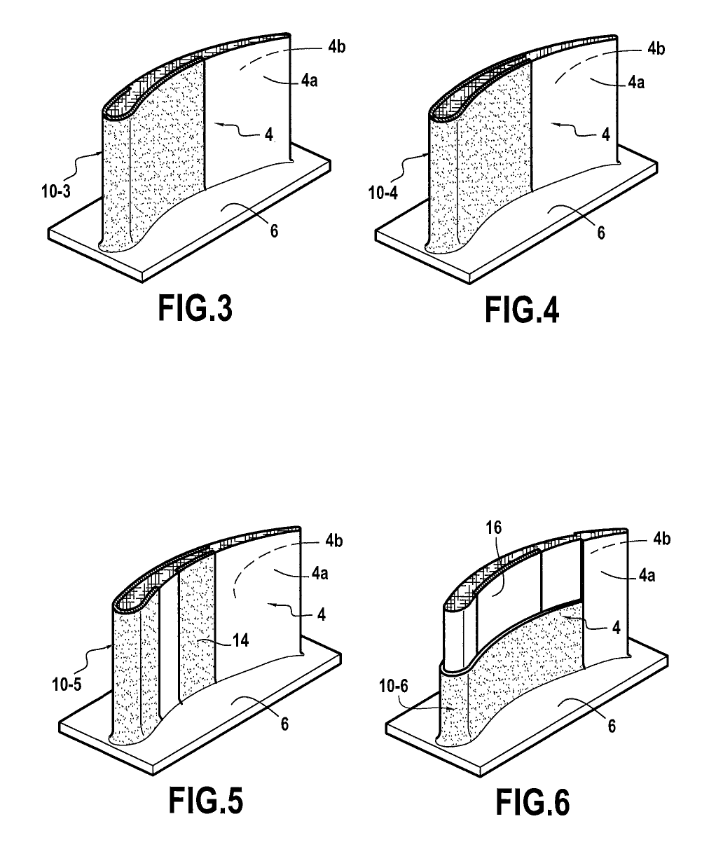

In a variant shown in FIG. 3, the reinforcing strip 10-3 is positioned asymmetrically, covering not only the leading edge of the airfoil, but also a portion of one of the side faces of the airfoil (specifically in this example the pressure side face 4a). This configuration makes it possible to increase the stiffness of the airfoil, thereby improving its ability to withstand stresses and improving its protection against erosion.

In another variant that is shown in FIG. 4, the reinforcing strip 10-4 is symmetrically positioned, covering not only the leading edge of the airfoil 4, but also portions of both side faces of the airfoil (namely the pressure side face 4a and the suction side face 4b). Compared with the previous variant, this configuration serves to further increase the stiffness of the airfoil and to avoid post-fabrication deformation.

It should be observed that the greater the coverage of the side faces of the airfoil by the strip, the greater the stiffness imparted to the airfoil.

It should also be observed that the shape of the reinforcing strip is not necessarily rectangular: for example, it may be of wave shape so as to respond to problems of deformation along the trailing edge at a common frequency.

In yet another variant that is shown in FIG. 5, the reinforcing strip 10-5 is positioned asymmetrically, covering the leading edge and a portion of the suction side face 4b of the airfoil 4. Furthermore, the side face of the airfoil that is not covered by the reinforcing strip (specifically the pressure side face 4a) is covered in part by another strip 14, likewise made of unidirectional fabric or of pre-impregnated textile.

The presence of this additional strip 14 serves to limit asymmetries of stiffness and/or of shrinkage/deformation during fabrication of the airfoil. In particular, the width of the strip 14 is a function of the amount of deformation to which the airfoil is subjected during fabrication.

In yet another variant shown in FIG. 6, the guide vane 2 also has a layer of viscoelastic material 16 that is interposed between the airfoil 4 and the reinforcing strip 10-6. This layer (or patch) 16 in the example shown in FIG. 6 is positioned over the pressure side face 4a of the airfoil and is covered by the reinforcing strip 10-6, which reinforcing strip may be positioned symmetrically so that it covers portions both of the pressure side and of the suction side of the airfoil.

The presence of this layer of viscoelastic material 16 thus serves to respond to vibratory, acoustic, or damping problems that are encountered by the guide vane. Specifically, this layer serves to absorb energy, and frequencies, and to attenuate vibratory modes, thereby limiting the vibration and deformation to which the guide vane is subjected in operation.

The layer of viscoelastic material 16 may be interposed between the airfoil and the reinforcing strip. Alternatively, it may be positioned within the reinforcing strip, i.e. it may be added between two successive plies making up the reinforcing strip.

By way of example, the viscoelastic material used may be of the elastomer, rubber, etc. . . . type.

There follows a description of various methods of fabricating the guide vane in accordance with the invention.

A first fabrication method is said to be a “thermo-compression” method. It enables a guide vane of the invention to be made as a single piece.

This thermo-compression fabrication method requires compression tooling made up of a shell having indentations (or cavities) formed therein for the guide vane that is to be fabricated, and possibly provided with an ejector system for extracting the fabricated part. These indentations are temperature regulated so as to bring the injected resin up to its melting temperature and thus “transform” the mat.

A first step of the method consists in making the fiber reinforcement that is to constitute the airfoil and the platforms of the guide vane. For this purpose, pre-impregnated “chips” are cut out from a strip of unidirectional or textile fabric, typically made of carbon fibers, with the dimensions (length and width) and the type of carbon used for the chips being a function of the level of stiffness desired for the guide vane. For example, the chips may present a width lying in the range 4 millimeters (mm) to 15 mm, and a width lying in the range 4 mm to 150 mm, or indeed 2 mm of width and/or of length.

The long fibers may be continuous or discontinuous prior to transformation as a function of the selected injection method. Discontinuous fibers present a length lying substantially in the range 2 mm to 100 mm, as a function of the size of the granules making up the resin.

The fibers are often discontinuous or they may be continuous as a function of the topology of the part, of the fiber volume content present in the resin, of the method used, of parameters of the transformation process, of rheological phenomena, and/or of interaction phenomena between fibers. The fibers conserve their initial length or else they are broken during the dynamic stage corresponding to filling so as to present a final fiber length distribution lying substantially in the range 0.1 mm to 100 mm.

These carbon fiber chips are then agglomerated so as to form a mat. This solution enables the chips to be manipulated easily prior to being positioned in the compression tooling. It is also possible merely to create a mass of chips (which are then positioned, “injected”, and inserted into the compression tooling).

The superposing and positioning of chips within the mat is random, but where possible with a pattern that can be repeated for reproducibility of the guide vanes. Preferably, the mat presents a structure that is isotropic in order to obtain mechanical properties that are uniform in a plane. The shape of the mat depends on the complexity of the guide vane that is to be fabricated (size, thickness, variation in shape, etc.).

It should be observed that the fiber reinforcement for making the platforms of the guide vane may be made using the same mat as is used for making the airfoil. Alternatively, the platforms may be made from a mat in which the aspect ratio (length/width of the carbon fiber chips) is smaller than for the airfoil. Indeed, the platforms are less stressed than the airfoil.

It should also be observed that the mat may be pre-polymerized, typically up to 20%-50% prior to being positioned in the cavities of the compression tooling, with such pre-polymerization thus making it possible to conserve resin for providing cohesion between the chips and the reinforcing strip. This leads to a so-called “washout” effect corresponding to resin migrating around the reinforcement. By way of example, for a resin of the epoxy family, the mat may be pre-polymerized to 30%.

Parallel to the step of creating such mats, the thermo-compression fabrication method consists in creating the reinforcing strip. This is made by a single strip of UD fabric or textile, typically made of carbon fibers, that is cut out, e.g. into the form of a rectangle. Alternatively, the reinforcing strip may be made by stacking a plurality of pre-impregnated plies of UD fabric or of textile, likewise made of carbon fibers.

In the following step of the method, the reinforcing strip and the mat for making fiber reinforcement constituting the airfoil and the platforms as prepared in this way are positioned in the cavities of the compression tooling.

If two types of mat are used, the mat for making the fiber reinforcement of the airfoil is positioned initially in a cavity of the compression tooling together with the reinforcing strip, and then the mat for making the platforms is positioned subsequently. Alternatively, they may be positioned at the same time in the same compression tooling. Also alternatively, they may be positioned at the same time in the same compression tooling in order to be subjected to pre-consolidation prior to being positioned in final compression tooling.

The compression tooling is then closed. The resin used for the pre-impregnated chips may be a thermosetting resin belonging to the family of epoxies, bismaleimides, polyimides, polyesters, vinylesters, cyanate esters, phenolic resins, etc. Alternatively, the resin may be a thermosetting resin of one of the following types: polyphenylene sulfide (PPS), polysulfone (PS), polyethersulfone (PES), polyamide-imide (PAI), polyetherimide (PEI), or indeed the family of polyaryletherketones (PAEK): PEK, PEKK, PEEK, PEKKEK, etc.

Closing the compression tooling leads to the mats and the reinforcing strip that have been placed inside the tooling being compressed, thereby enabling the mats to take on the shape of the cavities in the compression tooling. This compression step may be performed either by closing the compression tooling, or by moving movable cores present inside the compression tooling.

Together with the compression step, provision is made to regulate the temperature of the compression tooling so as to transform and polymerize the resin (i.e. curing a thermosetting resin or cooling a thermoplastic resin).

More precisely, with a thermosetting resin, it is advantageous to have recourse to a specific first heating cycle that is close to the melting temperature of the resin with controlled temperature-rise ramps for shaping the mats, followed by a second heating cycle that is likewise controlled for the purpose of consolidating/cross-linking/polymerizing the resin. This makes it possible for the mats add the reinforcing strip to be put into shape and to determine their cohesive/adhesive aspects.

With a thermoplastic resin, this second cycle is constituted by a cooling cycle so s to reach the ejection temperature of the part and thus ensure that the semicrystalline or amorphous polymers are properly crystallized/polymerized in order to obtain good mechanical properties and limit residual stresses and post-injection deformation.

The temperature of the compression tooling may be regulated by any known regulation means, e.g. by using heating cartridges, by regulation using water or oil, by an induction heating system, etc.

At the end of this step, the compression tooling is opened and the guide vane as obtained in this way is extracted (by using an ejector system or manually or automatically by means of a gripper).

A second method of fabricating the guide vane makes use of the above-described thermo-compression method for obtaining the airfoil of the guide vane (without platforms), followed by a step of overmolding previously prepared platforms on the airfoil by a method of injecting resin under pressure.

The method of fabricating the airfoil by thermo-compression is thus entirely identical to that described above.

The airfoil of composite material as made in this way is then placed in an injection mold in order to perform overmolding on the airfoil so as to make the platforms by using a thermoplastic or thermosetting resin (which may optionally be filled).

Reference may be made to French patent application No. 1357485 filed on Jul. 29, 2013 by Safran, which describes a method of assembling a metal leading edge by overmolding onto a composite material vane. In principle, that method can be applied to making platforms out of composite material on the airfoil made of composite material of the guide vane of the invention, likewise by overmolding.

Briefly, the overmolding method makes provision for a dynamic stage of filling the cavity of the injection mold by injecting resin under pressure, followed by a switching stage, and then a static compacting/holding stage and a stage of solidifying or cross-linking/curing the injected resin. After the resin has solidified, the injection mold is opened and the part (airfoil with its overmolded platforms) is ejected.

A third method of fabricating the guide vane applies the above-described thermo-compression method to obtain the airfoil of the guide vane possibly together with the platforms, a known injection method for fabricating the platforms (where necessary), and then a step of bonding the platforms on the airfoil by adhesive. This adhesive bonding step may be performed by known methods such as ultrasound bonding, depositing adhesive, etc.

1. A guide vane for a gas turbine engine, the guide vane comprising:
an airfoil made of composite material having fiber reinforcement densified by a matrix, the fiber reinforcement being obtained from pre-impregnated long fibers agglomerated in the form of a mat, the airfoil being provided at least on a leading edge with a reinforcing strip, said reinforcing strip being made from a single strip of unidirectional fabric or of textile, or by stacking a plurality of pre-impregnated plies of unidirectional fabric or of textile made of carbon fibers or of glass fibers; and
at least one platform positioned at a radial end of the airfoil, the platform being made of composite material having fiber reinforcement densified by a matrix, said fiber reinforcement being obtained from pre-impregnated long fibers.

2. A guide vane according to claim 1, wherein the reinforcing strip is positioned on the leading edge of the airfoil and covers at least part of one of the side faces of the airfoil.

3. A guide vane according to claim 2, wherein the side face of the airfoil that is not covered by the reinforcing strip is covered in part by another strip of unidirectional fabric so as to limit stiffness and shrinkage asymmetries during fabrication of the airfoil.

4. A guide vane according to claim 1, wherein the reinforcing strip is positioned at the leading edge of the airfoil and covers both side faces of the airfoil, at least in part.

5. A guide vane according to claim 1, wherein the reinforcing strip is positioned on the airfoil and on at least one connection fillet between the airfoil and the platform.

6. A guide vane according to claim 1, further including a layer of viscoelastic material that is interposed between the airfoil and the reinforcing strip or that is positioned within the reinforcing strip.

7. A guide vane according to claim 1, wherein the mats constituting the fiber reinforcement of the airfoil and of the platform are made from carbon fiber chips.

8. A turbine engine including at least one guide vane according to claim 1.

9. A method of fabricating a guide vane according to claim 1, the method comprising in succession:
positioning the reinforcing strip and the pre-impregnated long fibers that are agglomerated as mats in cavities of compression tooling in order to make fiber reinforcement making up the airfoil and the platform;
closing the compression tooling;
compressing the mats and the reinforcing strip while regulating the temperature and the closure pressure of the compression tooling in order to transform the composite used;
opening the compression tooling; and
unmolding the resulting guide vane.

10. A method of fabricating a guide vane according to claim 1, the method comprising in succession:
positioning the reinforcing strip and the pre-impregnated long fibers that are agglomerated as mats in cavities of compression tooling in order to make fiber reinforcement constituting the airfoil;
closing the compression tooling;
compressing the mats and the reinforcing strip while regulating the temperature and the closure pressure of the compression tooling in order to transform the composite used;
opening the compression tooling;
unmolding the resulting airfoil; and
overmolding a previously-prepared platform on the airfoil by a method of injecting resin under pressure.

11. A method of fabricating a guide vane according to claim 1, the method comprising in succession:
positioning the reinforcing strip and the pre-impregnated long fibers that are agglomerated as mats in cavities of compression tooling in order to make fiber reinforcement constituting the airfoil;
closing the compression tooling;
compressing the mats and the reinforcing strip while regulating the temperature and the closure pressure of the compression tooling in order to transform the composite used;
opening the compression tooling;
unmolding the resulting airfoil; and
adhesively bonding a previously-prepared platform on the airfoil.
